(19) United States
(12) Patent Application Publication
(10) Pub. No.: US 2014/0068938 A1
(43) Pub. Date: Mar. 13, 2014

(54) METHOD OF CLOCKING A TURBINE WITH SKEWED WAKES

(71) Applicant: Dennis Scott Holloway, Simpsonville, SC (US)

(72) Inventor: Dennis Scott Holloway, Simpsonville, SC (US)

(73) Assignee: General Electric Company, Schenectady, NY (US)

(21) Appl. No.: 13/608,534

(22) Filed: Sep. 10, 2012

(51) Int. Cl. B23P 6/00

(52) U.S. Cl. 29/889.1

(57) ABSTRACT

Clocking of downstream turbine airfoils can provide significant thermal and other performance benefits. The benefit from clocking the downstream airfoils is improved by skewing the airfoil wakes in the upstream turbine airfoils so that an increase in the amount of the radial spans of the clocked, downstream airfoils are impacted by the upstream wakes. This is achieved by skewing the upstream wakes using vortexing and restacking of the upstream airfoils so that the upstream wakes impact a mid-span portion of one clocked, downstream airfoil and two outer span portions of an adjacent clocked, downstream airfoil.

The present invention relates to turbines, and more particularly, to a method of clocking a turbine with skewed wakes.

### BACKGROUND OF THE INVENTION

The performance of gas turbines can be affected by thermal and pressure gradients. One major source of thermal gradients is the large circumferential and radial temperature non-uniformities (i.e., hot streaks and cooling wakes) in the flow exiting a turbine combustor. Another source of non-uniformity is wakes from upstream airfoils of the same frame of reference. It has been found that controlling the relative circumferential positions of gas turbine blades, known as clocking or indexing, can increase the efficiency of turbine stages and mitigate the effects of combustor hot streaks and upstream airfoil wakes. Thus, clocking of turbine airfoils can provide significant thermal and other performance benefits.

In practice, the clocking of turbomachinery is essentially a procedure of aligning airfoils of like count and reference frame (i.e., rotor to rotor and stator to stator) without any consideration of the optimal airfoil and wake shapes to get the best possible clocking design. For airfoils of like count, the relative position of a downstream stator to the wake emanating from an upstream stator can lead to significant swings in turbine efficiency and airfoil, platform and casing temperatures. The same applies to subsequent rotor stages. Often, an attempt is made to “straighten” the upstream wakes to get a greater benefit over the majority of the span of the downstream airfoil. However, this can lead to a very poor aerodynamic design of the upstream stage, in particular for the first stage of a high-pressure turbine (HPT). Since skewed wakes are almost “a given” in typical gas turbine designs, the present invention takes advantage of the wake shape by ensuring that one upstream wake impacts the leading edges of multiple downstream airfoils, thus, optimizing the benefit of wake shaping (i.e., airfoil gas temperature and aerodynamic performance).

The technical and commercial advantages of the present invention are a large performance impact (i.e., 0.5 pt stage efficiency) and a large durability impact (i.e., >100 degrees F. for airfoil gas temperature).

For stators of like count, the relative position of a downstream stator to the wake emanating from an upstream stator can lead to significant swings in turbine efficiency and hot gas path (HGP) surface temperatures. The same applies to subsequent rotor stages.

### BRIEF DESCRIPTION OF THE INVENTION

In an exemplary embodiment of the invention, a method of clocking a turbine, in which the turbine airfoils being comprised of at least a first, upstream row of airfoils in a first frame of reference, a second row of airfoils in the first frame of reference, which are downstream from the first row of airfoils, and a third row of airfoils in a second frame of reference, which are intermediate the first and second rows of airfoils, comprises the steps of changing a circumferential position of the row of downstream airfoils relative to a circumferential position of the row of upstream airfoils so that the downstream airfoils are more within the upstream airfoils' wakes than before the circumferential position of the row of downstream airfoils was changed, and skewing the upstream airfoils' wakes so that more of adjacent downstream airfoils' leading edges are within the upstream airfoil's wake than before the upstream airfoils' wakes were skewed.

In another exemplary embodiment of the invention, a method of clocking a turbine, in which the turbine is comprised of a plurality of airfoils, the turbine airfoils being comprised of at least a first, upstream row of airfoils in a first frame of reference, a second row of airfoils in the first frame of reference, which are downstream from the first row of airfoils, and a third row of airfoils in a second frame of reference, which are intermediate the first and second rows of airfoils, each downstream airfoil being formed from a plurality of design sections which are stacked relative to one another, comprising the steps of changing a circumferential position of the row of downstream airfoils relative to a circumferential position of the row of upstream airfoils so that the downstream airfoils are more within the upstream airfoils' wakes than before the circumferential position of the row of downstream airfoils was changed, and for each of the upstream airfoils, skewing the airfoil's wake so that the wake impacts a leading edge of a first, downstream clocked airfoil and a leading edge of a second, downstream clocked airfoil adjacent to the first downstream airfoil.

In a further exemplary embodiment of the invention, a method of clocking a turbine, in which the turbine is comprised of a plurality of airfoils, the turbine airfoils being comprised of at least a first, upstream row of airfoils in a first frame of reference, a second row of airfoils in the first frame of reference, which are downstream from the first row of airfoils, and a third row of airfoils in a second frame of reference, which are intermediate the first and second rows of airfoils, each downstream airfoil being formed from a plurality of design sections which are stacked relative to one another, comprising the steps of changing a circumferential position of the row of downstream airfoils relative to a circumferential position of the row of upstream airfoils so that the downstream airfoils are more within the upstream airfoils' wakes than before the circumferential position of the row of downstream airfoils was changed, and for each of the upstream airfoils, skewing the airfoil's wake so that the wake impacts a leading edge of a first, downstream clocked airfoil and a leading edge of a second, downstream clocked airfoil adjacent to the first downstream airfoil, the skewing of the upstream airfoil's wake being a function of vortexing between the upstream airfoil and other upstream airfoils adjacent to the upstream airfoil, a restacking of the upstream airfoil, or a combination of vortexing between the upstream airfoil and other, adjacent upstream airfoils and restacking of the upstream airfoil.

The present invention shows that clocking can be improved by skewing the airfoil wakes in the upstream stages of a turbine. The skewed airfoil wakes travel to the downstream stage where they impact the leading edges of multiple airfoils. The low total temperature and pressure wake of an upstream airfoil impact the mid-span of one downstream airfoil and the outer span of an adjacent airfoil. Not only is the clocking benefit improved for the downstream stage, but the upstream stage receives the additional benefit that normally comes with advanced vortexing that creates the skewed wake.

The gas turbine is designed/vortexed to be beneficial to the upstream stage performance, while the wake shape is skewed enough in the circumferential direction to ensure that it can impact adjacent airfoils downstream. Preliminary design can be done with 2D streamtube tools, while the final optimization is performed with 3D unsteady computational fluid dynamics (CFD) analysis. The simpler 2D streamtube analysis can be used to quickly decide which vortexing/stacking of the upstream airfoil will yield a wake that is close to the desired shape. The unsteady CFD is then used to evaluate the wake shape in a more physically realistic environment, which is due to the proper inclusion of the intermediate bladerow's unsteady effect on the upstream wake. The two approaches may be iterated further to obtain an improved wake shape.

### BRIEF DESCRIPTION OF THE DRAWINGS

FIG. 1 is a simplified schematic diagram of a multi-stage gas turbine system.

FIG. 2 is a two dimensional (2D) cross-sectional view of airfoil clocking in a turbo machine, such as a turbine.

FIG. 3 is a partial perspective view of a downstream, clocked turbine airfoil with an upstream airfoil's straight two dimensional (2D) wake near the downstream, clocked airfoil's leading edge.

FIG. 4 is a partial perspective view of a downstream, clocked turbine airfoil with an upstream airfoil's mild three dimensional (3D) wake near the downstream, clocked airfoil's leading edge.

FIG. 5 is a partial perspective view of a downstream, clocked turbine airfoil with an upstream airfoil's strong/skewed three dimensional (3D) wake near the downstream, clocked airfoil's leading edge.

FIG. 6 is a partial perspective view of multiple downstream, clocked turbine airfoils with an upstream airfoil's mild three dimensional (3D) wake having been skewed to impact the downstream, clocked airfoils.

FIG. 7 is a partial perspective view of multiple downstream, clocked turbine airfoils with an upstream airfoil's strong/skewed three dimensional (3D) wake having been skewed to impact the downstream, clocked airfoils.

FIG. 8 is a two-dimensional cross section showing the throat plane between adjacent upstream airfoils, which is the plane of minimal distance between such adjacent airfoils.

FIG. 9 is a graph showing a linear radial throat distribution for a two dimensional cross section between adjacent upstream airfoils.

FIG. 10 is a graph showing a non-linear radial throat distribution for a two dimensional cross section between adjacent upstream airfoils.

FIG. 11 is a partial perspective view of a typical turbine airfoil, such as a stator or rotor blade.

FIG. 12 is a partial perspective view of the turbine airfoil of FIG. 11 with the design sections of the airfoil restacked and reshaped.

FIG. 13 is a graph depicting Total Pressure versus Circumferential Position at Downstream Airfoil Leading Edge at a Generic Span (i.e., Momentum Wake).

FIG. 14 is a graph depicting Total Temperature versus Circumferential Position at Downstream Airfoil Leading Edge at a Generic Span (i.e., Thermal Wake).

### DETAILED DESCRIPTION OF THE INVENTION

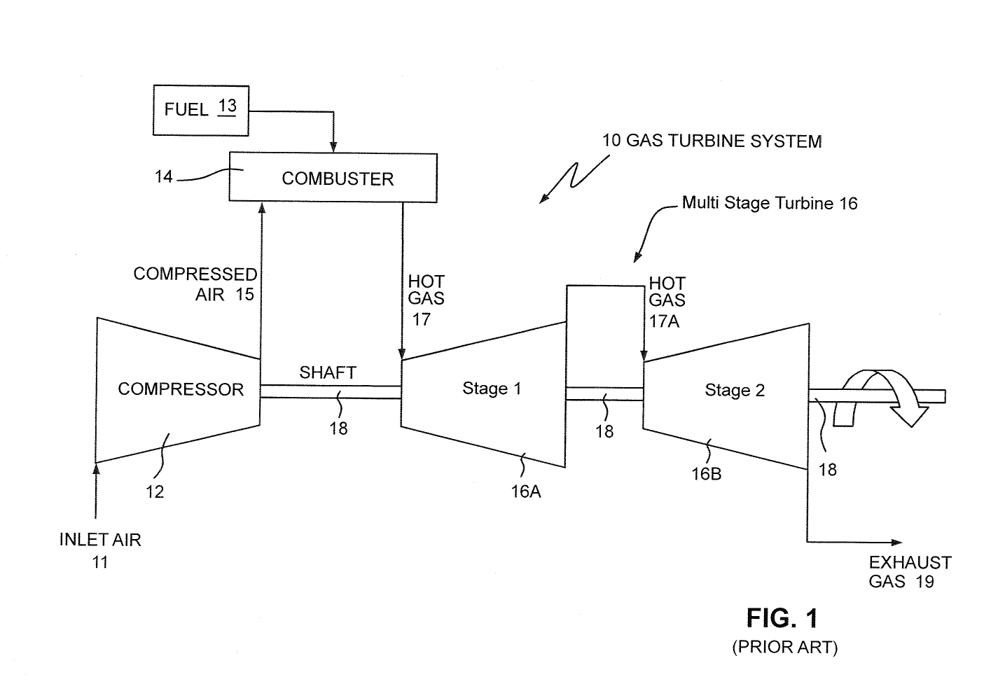

FIG. 1 is a simplified schematic diagram of a gas turbine system 10. The gas turbine system 10 shown in FIG. 1 includes a compressor 12, which compresses incoming air 11 to a high pressure, a combustor 14, which burns fuel 13 so as to produce a high-pressure, high-velocity hot gas 17, and a multi-stage turbine 16, which extracts energy from the high-pressure, high-velocity hot gas 17 entering the turbine 16 from the combustor 14 using turbine blades (not shown in FIG. 1) that are rotated by the hot gas 17 passing through them. As the turbine 16 is rotated, a shaft 18 connected to the turbine 16 is caused to be rotated as well. The embodiment of turbine 16 shown in FIG. 1 is a two-stage turbine with first and second stages designated as 16A and 16B, respectively. To maximize turbine efficiency, the hot gas 17/17A is expanded (and thereby reduced in pressure) as it flows from the first stage 16A of turbine 16 to the second stage 16B of turbine 16, generating work in the different stages of turbine 16 as the hot gas 17 passes through. In a gas turbine engine, a single turbine section is made up of either a disk that holds many turbine stator blades or a rotating hub that holds many turbine rotor blades. The turbine blades are responsible for extracting energy from the high temperature, high pressure gas 17 produced by the combustor 14 that flows through the turbine blades. Eventually, exhaust gas 19 exits the last stage of turbine 16, which is shown in FIG. 1 as the second stage 16B.

FIG. 2 is a two dimensional (2D) cross-sectional view 20 of “airfoil clocking” in a turbo-machine, such as turbine 16. Turbo-machinery airfoil clocking involves three blade rows. Two blade rows are in the same frame of reference; that is, two blade rows are both either stators or rotors. One of the two blade rows is an upstream airfoil. The other of the two blade rows is a downstream airfoil. The third blade row, which is intermediate the two blade rows, rotates relative to the other two blade rows. The downstream airfoil is “clocked”, i.e., circumferentially positioned, relative to the wake of the upstream airfoil.

The clocked airfoil count needs to be an integral multiple of the upstream blade row, such that typically a ratio of 1:1 would be used. But, it should be noted that other ratios, such as 2:1, etc., could also be used, because they could see some benefit, as well, to the clocking of downstream airfoils relative to upstream airfoils.

FIG. 2 shows a series of turbine rotors and stators, which include an upstream stator 24, an upstream rotor 25, a downstream, clocked stator 26 and a downstream, clocked rotor 27. The upstream rotor 25 and the downstream, clocked rotor 27 are each rotating in a direction indicated by an arrow 21. The upstream stator 24 produces a wake 22. Similarly, the upstream rotor 25 produces a wake 23. The downstream airfoil, i.e., downstream stator 26 is clocked relative to the upstream stator 24. The downstream airfoil, i.e., rotor 27, is clocked relative to the upstream rotor 25.

For stators of like count, the relative position of a downstream stator to the wake emanating from an upstream stator can lead to significant swings in turbine efficiency and hot gas path (HGP) surface temperatures. The same applies to subsequent rotor stages. It is often difficult to obtain a perfectly “straight” wake for optimal clocking benefit. Usually there is a decrease in performance of the upstream stage, or at minimum, there is a reduction in design space. The present invention shows by skewing the wakes in the upstream stage that the clocking benefit can be equal to that obtained from “straightening” the upstream wake. A properly skewed wake (tailored) can impact multiple downstream airfoils. This is an optimal method for low aspect ratio stages, such as the first stage of a high pressure turbine (HPT), since separate studies have found a slightly greater clocking benefit (performance) for a skewed wake compared to a “straightened” wake. This leads to an increase in overall turbine efficiency since the upstream stage typically shows a performance increase due to skewing the wakes from the upstream stage and the downstream stage will get essentially the same or better benefit due to clocking. There is also an additional thermal benefit since the thermal clocking effect on the downstream airfoils will be more robust (i.e., the airfoil will be less sensitive to clocking position).

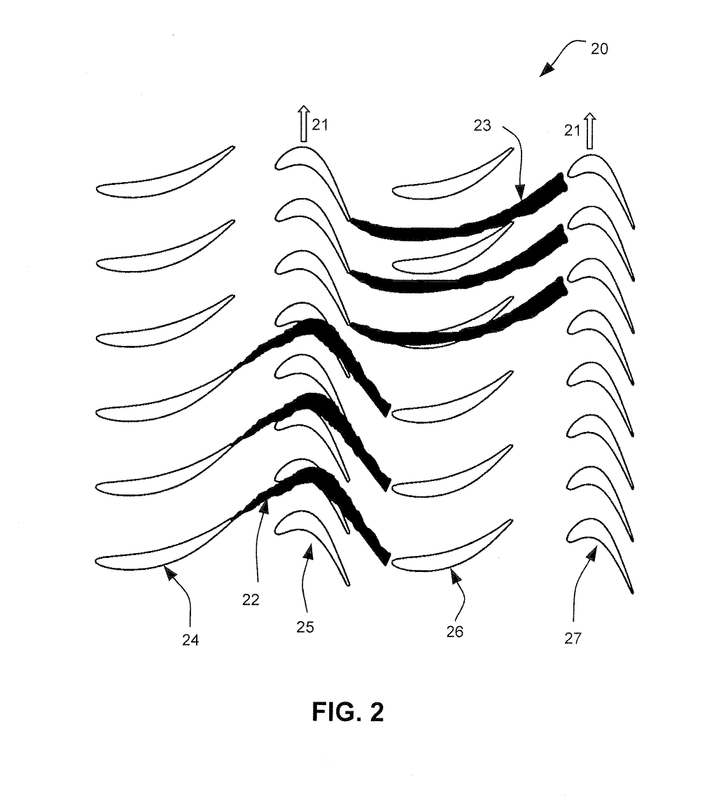

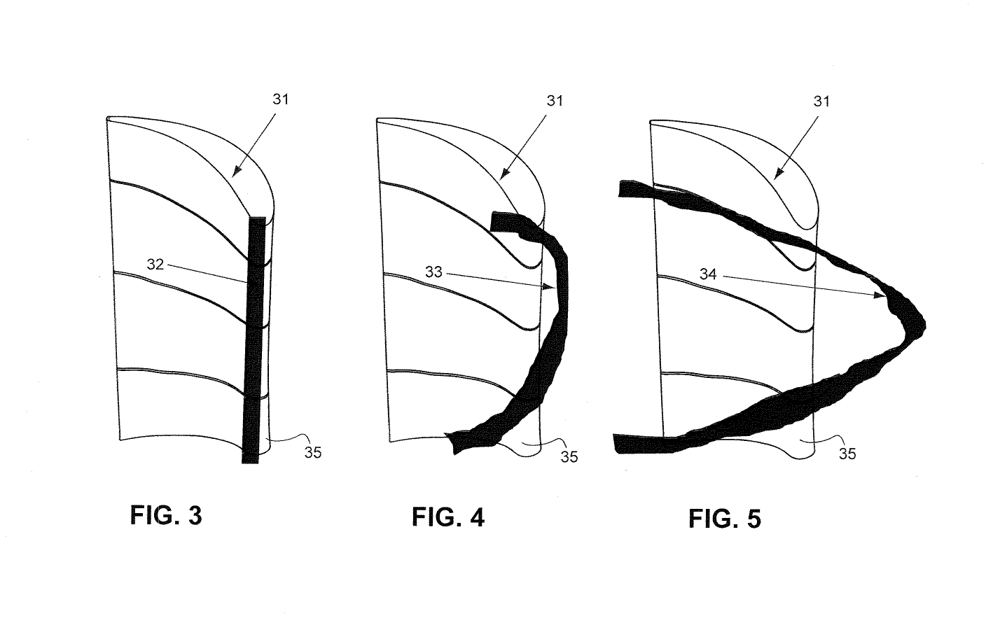

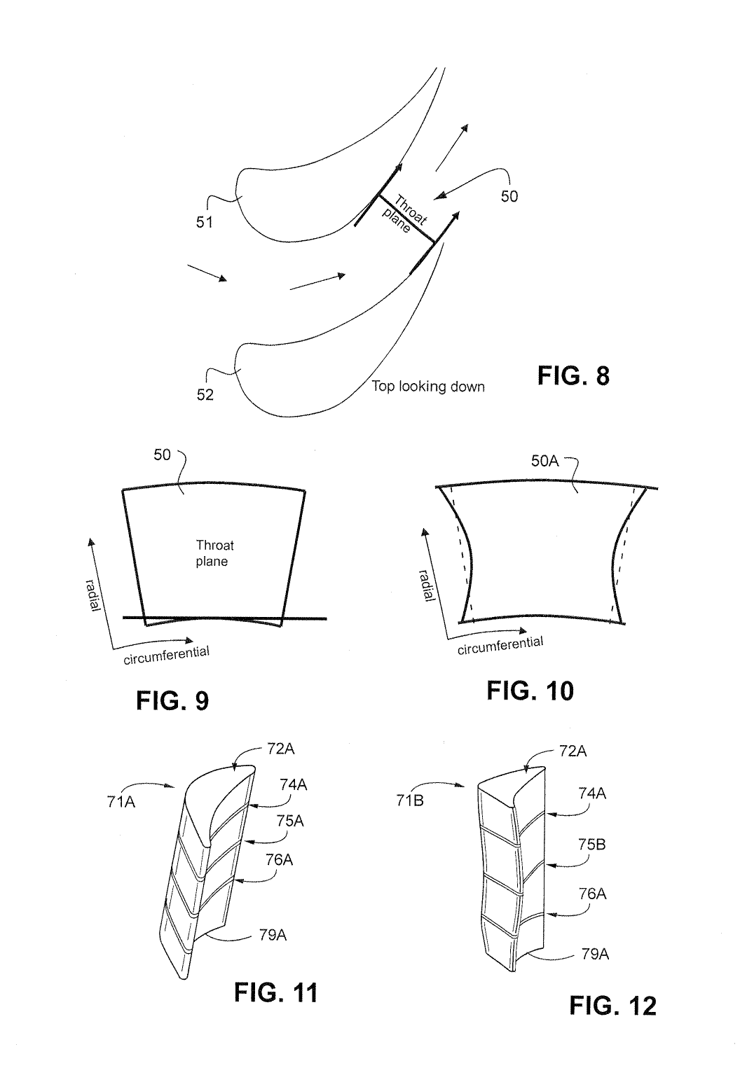

The shape of a wake from an upstream airfoil, as seen at the downstream, clocked airfoil's leading edge can take on many shapes. The shape of this wake will depend on the vortexing (radial throat distribution), restacking of the upstream stage (stators and rotors), and other factors. FIG. 3 is a partial perspective view of a downstream, clocked turbine airfoil 31 with an upstream airfoil's straight, two dimensional (2D) wake 32 near the clocked airfoil's leading edge 35. FIG. 4 is a partial perspective view of the downstream, clocked turbine airfoil 31 with an upstream airfoil's mild, three dimensional (3D) wake 33 near the clocked airfoil's leading edge 35. FIG. 8 is a partial perspective view of the downstream, clocked turbine airfoil 31 with an upstream airfoil's strong/skewed three dimensional (3D) wake 34 near the clocked airfoil's leading edge 35.

For a “straight”, clocked downstream airfoil, it may be advantageous to straighten the wake of the upstream airfoil, i.e., make the wake more two dimensional. However, for many turbine applications, such as the first stages of a gas turbine or a jet engine high pressure turbine, it would be impossible or an overall detriment to design the upstream turbine stage with this kind of constraint.

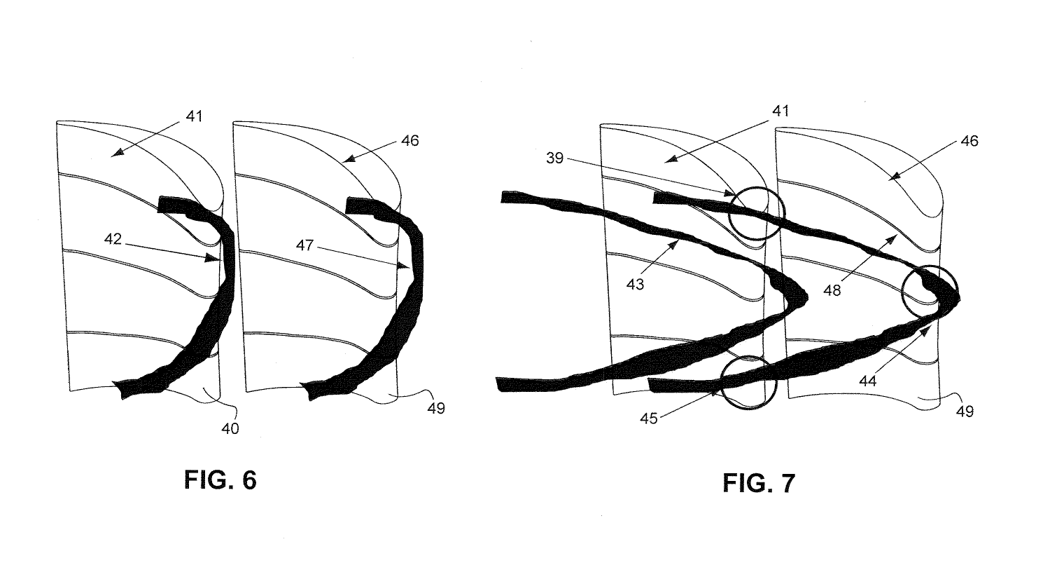

FIG. 6 is a partial perspective view of two, adjacent downstream, clocked turbine airfoils 41 and 46 with upstream airfoils' mild, three dimensional wakes 42 and 47 near the clocked airfoils' 41 and 46 leading edges 40 and 49. For the mild, three dimensional wakes 42 and 47, there will be some portion of the radial spans of the airfoils 41 and 46 that cannot sit in the respective wakes 42 and 47. However, the wakes 42 and 47 can be skewed, by vortexing or stacking of the upstream airfoils so that the upstream airfoils' wakes will impact multiple downstream, clocked airfoils, such as clocked, adjacent airfoils 41 and 46.

FIG. 7 is a partial perspective view of the downstream, clocked turbine airfoils 41 and 46 of FIG. 6 with upstream airfoils' strong/skewed three dimensional wake 43 and 48 having been skewed to impact clocked, adjacent airfoils near their respective leading edges. Thus, as shown in FIG. 4B, strong/skewed wake 48 impacts the leading edge 40 of downstream, clocked airfoil 41 at points 45 and 39, and the leading edge 49 of downstream, clocked airfoil 46 at point 44, so that the mid-span of airfoil 41 and the inner and outer span portions 45 and 39 of adjacent airfoil 46 are impacted by wake 43.

Thus, it can be seen from FIG. 7 that, in general, a clocked, downstream airfoil will not be in the wake of an upstream airfoil over the downstream airfoil's entire span, because wakes and airfoils are three dimensional in shape. It can also be seen from FIG. 7 that it may be advantageous to redesign the upstream stage airfoils, by vortexing and/or stacking so that one upstream airfoil's wake impacts multiple downstream airfoils, such that the mid-span of one airfoil and the outer and inner portions of the span of an adjacent airfoil are impacted by the upstream airfoil's wake.

The objective of the present invention is to increase the amount, i.e., the percent (%), of the radial span/height of a clocked, downstream airfoil that can take advantage of the wake of an upstream airfoil by tailoring (skewing) the upstream wake to impact a mid-span portion of one airfoil and two outer span portions of an adjacent airfoil. However, it should be noted that the present invention is not directed to a specific wake shape or upstream stage design.

As noted above, the shape of a wake from an upstream airfoil, as seen at a downstream, clocked airfoil's leading edge, will depend on the vortexing (radial throat distribution) and/or restacking of the upstream stage airfoils (i.e., stators and rotors) and other factors. The upstream airfoil wake originates from the trailing edge of the upstream airfoil, and at that point, the wake shape matches the shape of the trailing edge. The vortexing of the upstream airfoil will determine the radial distribution of the flow angle or tangential swirl exiting that airfoil. Stacking of the upstream airfoil will determine the body forces acting on the flow at the upstream airfoil trailing edge. It is the radial distribution of body forces and flow swirl that will impact how the shape of the wake transforms as it leaves the upstream airfoil's trailing edge and travels to the downstream, clocked airfoil's leading edge. A 2D streamtube analysis can be used to obtain an approximate wake shape at the downstream airfoil's leading edge. Performing an unsteady 3D CFD analysis that includes at least the upstream, downstream, and intermediate bladerow will capture the distortion of the wake shape by the unsteady interaction of the intermediate bladerow and 3D secondary flow effects.

The first step in skewing the wake would be to use a 2D streamtube analysis to obtain an idealized wake shape. Iterations using the 2D streamtube analysis could be employed until the desired skewness is achieved. These iterations would involve changing the vortexing/stacking of the upstream airfoil. A more realistic description of the wake shape could then be determined by performing a 3D unsteady CFD analysis of at least three bladerows.

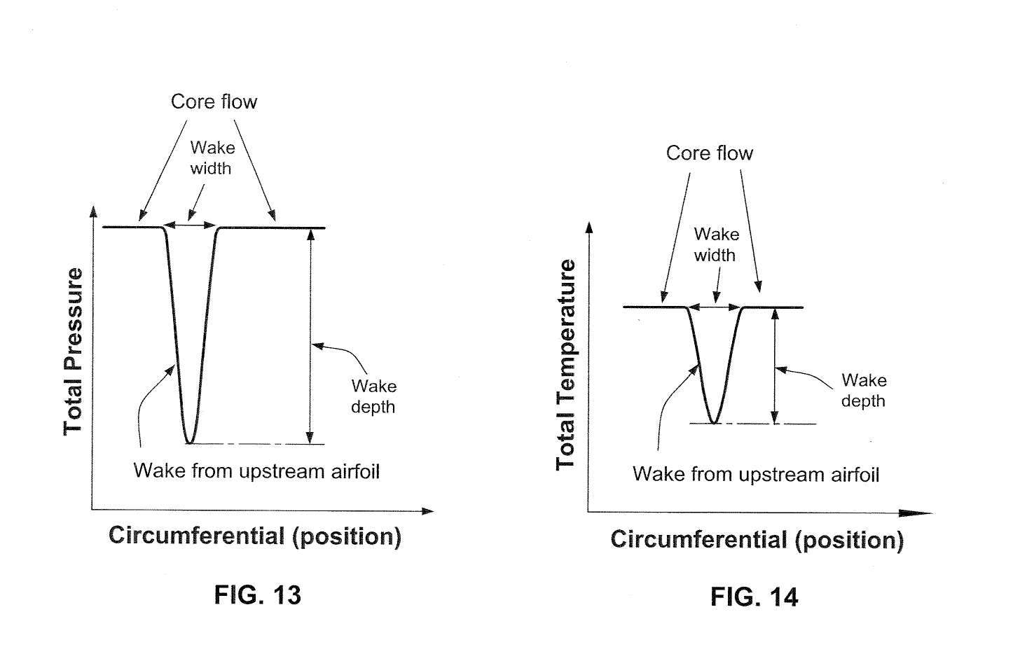

To evaluate the downstream airfoil position relative to the momentum wake, the total pressure as a function of circumferential position at the leading edge of a generic radial span of the downstream airfoil. This is shown in FIG. 13. If the leading edge of the downstream airfoil is at the circumferential location as the low total pressure shown in FIG. 13, then the downstream airfoil can be considered to be in the momentum wake. If not, the entire process can be repeated until the desired benefit is achieved.

FIG. 14 shows the total temperature as a function of circumferential position (i.e., the thermal wake) at the leading edge of a generic radial span of the downstream airfoil. If the leading edge of the downstream airfoil is at the circumferential location as the low total temperature shown in FIG. 13, then the downstream airfoil can be considered to be in the thermal wake. If not, the entire process can be repeated until the desired benefit is achieved.

The clocking of the downstream airfoil can also be measured during a rotating rig or engine test. For example, a traverse probe could be placed upstream of the leading edge of the downstream, clocked airfoil. The probe could be traversed circumferentially to measure total temperature and pressure at various spans to produce lots similar to FIGS. 13 and 14.

FIG. 8 is a two-dimensional cross section of clocked, adjacent downstream airfoils 51 and 52 showing the throat plane 50 between such adjacent airfoils. In FIG. 8, the throat is the minimal distance between the adjacent airfoils 51 and 52, as measured using the throat plane 50.

FIG. 9 is a graph showing the radial throat distribution for a two dimensional cross section between adjacent upstream airfoils. For a two dimensional cross section, the width of the throat plane can change as a function of radial height of adjacent, upstream airfoils, such as airfoils 51 and 52. Thus, in FIG. 9, the throat is shown as being a linear function of the radial height of the adjacent upstream airfoils. This would be typical of a 2D wake, such as the one shown in FIG. 3.

FIG. 10 is a graph showing the radial throat distribution for a two dimensional cross section between adjacent, upstream airfoils. For a two dimensional cross section, the width of the throat plane can change as a function of the radial height of the adjacent upstream airfoils, such as airfoils 51 and 52, and the stacking of such upstream airfoils. Thus, in FIG. 10, the throat is shown as being a non-linear function of the radial height of the adjacent, upstream airfoils. This would be typical of a 2D wake, such as the ones shown in FIGS. 4 and 5.

FIG. 11 is a partial perspective view of a typical turbine airfoil 71A, such as a stator or rotor blade. FIG. 12 is a partial perspective view of a restacked airfoil 71B, which is the turbine airfoil 71A of FIG. 11 with the design sections of the airfoil restacked, revortexed, and reshaped. Typically, an airfoil, like airfoil 71A shown in FIG. 11 includes an outer radial span design section 72A, an 80% radial span design section 74A, a 50% radial span design section 75A, a 20% radial span design section 76A and an inner radial span design section 79A. This would be typical of an airfoil that produces a 2D wake at the leading edge of the downstream airfoil. FIG. 12 shows the turbine airfoil 71B after restacking, vortexing, and reshaping the radial span design sections. This would be typical of an airfoil that produces a skewed 3D wake at the leading edge of the downstream airfoil.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of clocking a turbine, the turbine being comprised of a plurality of airfoils, the turbine airfoils being comprised of at least a first, upstream row of airfoils in a first frame of reference, a second row of airfoils in the first frame of reference, which are downstream from the first row of airfoils, and a third row of airfoils in a second frame of reference, which are intermediate the first and second rows of airfoils, the method comprising the steps of:
changing a circumferential position of the row of downstream airfoils relative to a circumferential position of the row of upstream airfoils so that the downstream airfoils are more within the upstream airfoils' wakes than before the circumferential position of the row of downstream airfoils was changed, and skewing the upstream airfoils' wakes so that more of adjacent downstream airfoils' leading edges are within the upstream airfoil's wake than before the upstream airfoils' wakes were skewed.

2. The method of claim 1, wherein each wake of an upstream airfoil is skewed so that the skewed wake of the upstream airfoil impacts at least two adjacent downstream airfoils.

3. The method of claim 1, wherein the skewed wake of the upstream airfoil impacts a mid-span portion of one downstream airfoil and two outer span portions of an adjacent downstream airfoil.

4. The method of claim 1, wherein the skewing of the upstream airfoils' wakes is a function of vortexing of the upstream airfoils.

5. The method of claim 4, wherein the vortexing of the upstream airfoils corresponds to radial throat distributions between the upstream airfoils.

6. The method of claim 1, wherein the skewing of the upstream airfoils' wakes is a function of restacking of the upstream airfoils.

7. The method of claim 1, wherein the skewing of the upstream airfoils' wakes being a function of vortexing between adjacent upstream airfoils, restacking of the upstream airfoils, or a combination of vortexing between adjacent upstream airfoil and restacking of the upstream airfoils.

8. The method of claim 1, wherein the skewing of the upstream airfoils' wakes results in a percentage of each downstream airfoil's radial span/height being impacted by upstream airfoil wakes being an increase over a percentage of the downstream airfoil's radial span/height before the skewing of the upstream airfoils' wakes.

9. The method of claim 1, wherein where a clocked downstream airfoil is straight along the downstream airfoil radial span/height, a wake of an upstream airfoil impacting the downstream airfoil is straightened.

10. The method of claim 1, wherein where a wake of an upstream airfoil impacting a first, clocked downstream airfoil is a mild, three dimensional wake, such that a portion of the first downstream airfoil's radial span/height impacted by the upstream airfoil's wake does not sit in the upstream airfoil's wake, the upstream airfoil's wake is skewed by vortexing or stacking of the upstream airfoil so that the upstream airfoil's wake becomes a strong/skewed wake which impacts the first downstream airfoil and a second, clocked downstream airfoil adjacent to the first downstream airfoil.

11. The method of claim 6, wherein each upstream airfoil is formed from a plurality of design sections which are stacked relative to one another.

12. The method of claim 10, wherein each upstream airfoil is skewed by restacking the plurality of design sections forming the downstream airfoil relative to one another circumferentially.

13. The method of claim 11, wherein the plurality of design sections includes an outer radial span design section, an 80% radial span design section, a 50% radial span design section, a 20% radial span design section and an inner radial span design section.

14. The method of claim 1, wherein the upstream and downstream rows of airfoils are both either stators or rotors and the intermediate row of airfoils is a rotor, if the upstream and downstream rows of airfoils are both stators, or is a stator, if the upstream and downstream rows of airfoils are both rotors.

15. The method of claim 1, wherein the upstream and downstream rows of airfoils together and the intermediate row of airfoils are rotating relative to each other.

16. A method of clocking a turbine, the turbine being comprised of a plurality of airfoils, the turbine airfoils being comprised of at least a first, upstream row of airfoils in a first frame of reference, a second row of airfoils in the first frame of reference, which are downstream from the first row of airfoils, and a third row of airfoils in a second frame of reference, which are intermediate the first and second rows of airfoils, the method comprising the steps of:
changing a circumferential position of the row of downstream airfoils relative to a circumferential position of the row of upstream airfoils so that the downstream airfoils are more within the upstream airfoils' wakes than before the circumferential position of the row of downstream airfoils was changed, and
for each of the upstream airfoils, skewing the airfoil's wake so that the wake impacts a leading edge of a first, downstream clocked airfoil and a leading edge of a second, downstream clocked airfoil adjacent to the first downstream airfoil.

17. The method of claim 1, wherein the skewed wake of the upstream airfoil impacts a mid-span portion of the first downstream airfoil and two outer span portions of the second, adjacent downstream airfoil.

18. The method of claim 1, wherein the skewing of the upstream airfoil's wake is a function of vortexing between the upstream airfoil and other upstream airfoils adjacent to the upstream airfoil.

19. The method of claim 16, wherein the skewing of the upstream airfoil's wake is a function of restacking of the upstream airfoil.

20. A method of clocking a turbine, the turbine being comprised of a plurality of airfoils, the turbine airfoils being comprised of at least a first, upstream row of airfoils in a first frame of reference, a second row of airfoils in the first frame of reference, which are downstream from the first row of airfoils, and a third row of airfoils in a second frame of reference, which are intermediate the first and second rows of airfoils, the method comprising the steps of:
changing a circumferential position of the row of downstream airfoils relative to a circumferential position of the row of upstream airfoils so that the downstream airfoils are more within the upstream airfoils' wakes than before the circumferential position of the row of downstream airfoils was changed, and for each of the upstream airfoils, skewing the airfoil's wake so that the wake impacts a leading edge of a first, downstream clocked airfoil and a leading edge of a second, downstream clocked airfoil adjacent to the first downstream airfoil, the skewing of the upstream airfoil's wake being a function of vortexing between the upstream airfoil and other upstream airfoils adjacent to the upstream airfoil, a restacking of the upstream airfoil, or a combination of vortexing between the upstream airfoil and other, adjacent upstream airfoils and restacking of the upstream airfoil.
